(19) United States
(12) Patent Application Publication
(10) Pub. No.: US 2018/0018889 A1
(43) Pub. Date: Jan. 18, 2018

(54) DETERMINE ATTENTION SPAN STYLE TIME CORRELATION INFORMATION

(71) Applicant: Hewlett-Packard Development Company, L.P., Fort Collins, CO (US)

(72) Inventors: Georgia Koutrika, Palo Alto, CA (US); Udi Chatow, Palo Alto, CA (US)

(21) Appl. No.: 15/545,686

(22) PCT Filed: Jan. 30, 2015
(86) PCT No.: PCT/US2015/013750

§ 371 Date: Jul. 22, 2017

(51) Int. Cl. G09B 5/02; G06N 99/00

(52) U.S. Cl. CPC G09B 5/02; G06N 99/005

(57) ABSTRACT

Examples disclosed herein relate to determine attention span style time correlation. In one implementation, a processor determines, based on information related to a users navigation of digital material and stored classifier information, time correlation information related to the users attention span style. The processor may output information related to the determination

### BACKGROUND

A reader's attention span may affect his ability to learn. For example, a reader with a high attention span may be able to better concentrate on learning material, and as a result, to better learn the material. As another example, another reader with a shorter attention span may learn in shorter periods of intense concentration.

### BRIEF DESCRIPTION OF THE DRAWINGS

The drawings describe example embodiments. The following detailed description references the drawings, wherein:

FIG. 1 is a block diagram illustrating one example of a computing system to determine attention span style time correlation information.

FIG. 2 is a flow chart illustrating one example of a method to determine attention span style time correlation information.

FIG. 3 is a diagram illustrating one example of a timeline indicating attention span style time correlation information.

FIG. 4 is a diagram illustrating one example of determining aggregate attention span style data.

FIG. 5 is a diagram illustrating one example of a graph to display a comparison of attention span style time correlation information related to multiple users.

### DETAILED DESCRIPTION

In one implementation, a processor analyzes stored navigation data related to a user's interaction with digital material. The processor may apply the stored navigation data to stored classifier information to determine attention span style time correlation information related to the user. The processor may determine the attention span style time correlation information by accessing stored information related to the users navigation of digital learning material during different sessions, such as sessions for using the same piece of learning material or related to different pieces of learning material. The attention span style time correlation information may indicate different attention span styles of the user and time periods associated with them. The attention span style time correlation information may be related to additional factors, such as where there is a first attention span style time correlation information related to science learning material and a second attention span, style time correlation information related to literature learning material.

The time correlation information may be related to any suitable time information. For example, the time periods may be relative time periods related to a study session, such as where a user sustains a higher attention span for the first hour of a study session. The time correlation information may be used to associate a time of day with an attention span style, such as where a user sustains a higher attention span in the morning versus the afternoon. The time correlation information may be associated with time spent on a piece of learning material, such as changes as a user finishes the contents of an electronic book.

The time correlation information may be used, for example, to create and/or sequence learning material or a curriculum. The particular time frame or relative time frame of an attention span style may be used to tailor a curriculum for a user. In addition, aggregate information related to the time correlation, such as related to the percentage of time spent with a particular attention span style or the comparative amount of total time with particular sets of attention span styles, may be taken into account. Using the attention span style information and associated time based information may be used to create a better tailored learning plan, resulting in better learning outcomes.

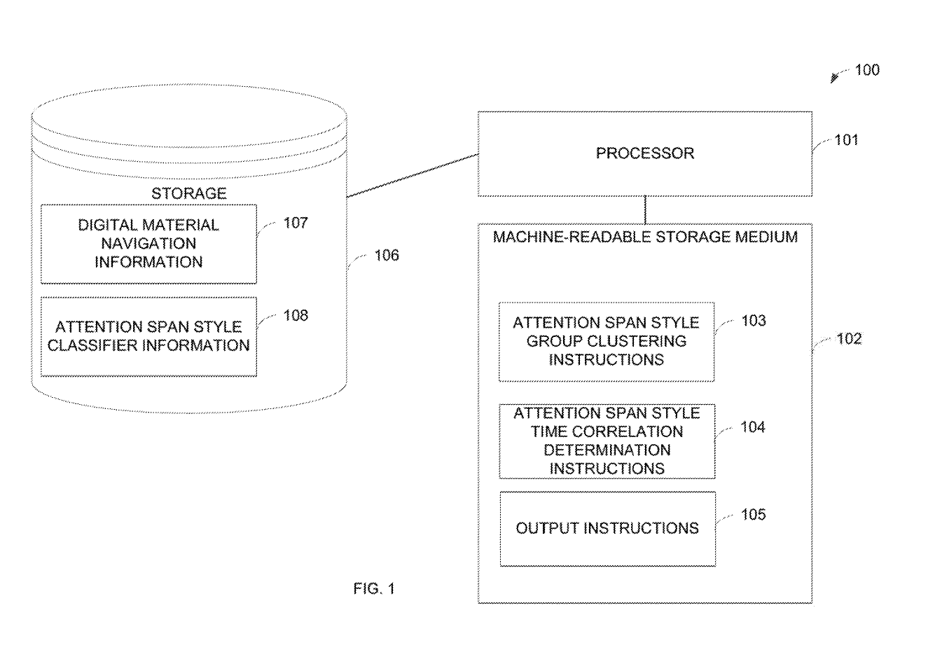

FIG. 1 is a block diagram illustrating one example of a computing system 100 to determine attention span style time correlation information. The computing system 100 may analyze stored digital material navigation data to determine attention span style information and associated time information. For example, the computing system 100 may analyze navigation data related to a user's interaction with different digital learning materials during different time periods to determine predictive information related to attention span styles and relative time periods for the user. The computing system 100 includes a processor 101, a machine-readable storage medium 102, and a storage 106.

The storage 106 may be any suitable type of storage in communication with the processor 101. The storage 106 may communicate with the processor 101 directly or via a network. The storage 106 includes digital material navigation information 107 and attention span style classifier information 108. A user computing device may communicate with the storage 106. For example, a user computing device and/or a processor in communication with the user computing device may send navigation data to the storage 106 related to the user's navigation of digital material. The storage 106 may associate user device or user account information with the user such that the storage 106 may store navigation data related to multiple users.

The digital material navigation information 107 may include information about material selections by a user and time information associated with the selections. For example, the stored digital material navigation information 107 may include a selection and time stamp and/or information related to the relative position of the selection to the previous selection. For example, the digital material navigation information 107 may indicate that the selection is 5 pages forward in an e-book 10 minutes after the previous selection. In one implementation, the navigation information also includes information related to navigation of printed books, such as where a user reads the book in a setting with a sensor to detect selected pages. A computing system may recognize the selected page and associate with a time stamp.

The attention span style classifier information 108 may include information related to a classifier for associating navigation data with an attention span style. For example, the processor 101 or another processor may create a machine-learning method for classifying a set of navigation selections and time data with an attention span style. The attention span style classifier information may be created based on interactions of multiple users with digital material.

The processor 101 may be a central processing unit (CPU), a semiconductor-based microprocessor, or any other device suitable for retrieval and execution of instructions. As an alternative or in addition to fetching, decoding, and executing instructions, the processor 101 may include one or more integrated circuits (ICs) or other electronic circuits that comprise a plurality of electronic components for performing the functionality described below. The functionality described below may be performed by multiple processors.

The processor 101 may communicate with the machine-readable storage medium 102. The machine-readable storage medium 102 may be any suitable machine readable medium, such as an electronic, magnetic, optical, or other physical storage device that stores executable instructions or other data (e.g., a hard disk drive, random access memory, flash memory, etc.). The machine-readable storage medium 102 may be, for example, a computer readable non-transitory medium. The machine-readable storage medium 102 may include attention span style group clustering instructions 103, attention span style time correlation determination instructions 104, and output instructions 105.

The attention span style group clustering instructions 103 may include instructions to group portions of navigation data that are representative of a similar attention span style. For example, a slow forward navigation may indicate a higher attention span level than jumping erratically between pages of an e-book. In some cases, a machine-learning method may be used to perform the grouping. In some cases, some actions not associated with the learning style may still be grouped together, such as where a single backward selection in an otherwise slow forward moving progression may still be associated with a high attention span style. The groups may be contiguous time segments such that each group is associated with a time frame.

The grouped navigation actions may be analyzed by the processor to associate them with an attention span style, such as a learning type or attention span level. In one implementation, the clustering is done in a manner that automatically associates with a style, such as where the clustering method adapts the types to a particular style group. The attention span style association may be performed based on a comparison of the grouped navigation data to the attention span style time classifier information 108.

The attention span style time orrelation determination instructions 104 may include instructions to determine attention span style time correlation information associated with the user based on the attention span style associated with multiple time periods and user navigation information from multiple pieces of digital material. For example, an aggregate predictive timeline may be created. The attention span style information may be analyzed and aggregated in any suitable manner, such as based on particular types of learning material, learning settings, or learning times.

The output instructions 105 may include instructions to output information related to the attention span style time correlation. For example, the processor 101 may transmit, display, or store the attention span style time correlation information. The processor may use the attention span style time correlation to customize learning materials and/or learning curriculum. For example, learning material may be selected and/or sequenced based on the attention span style of the user and the changes of the attention span style over time.

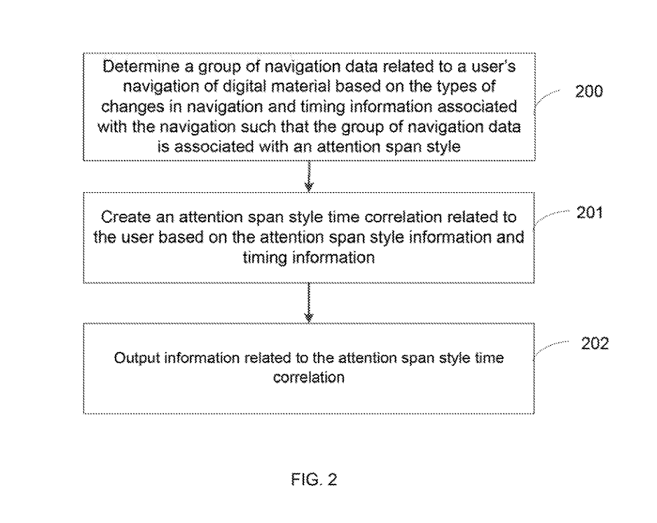

FIG. 2 is a flow chart illustrating one example of a method to determine attention span style time correlation information. For example, a processor may analyze stored navigation data related to a user's interaction with digital learning material. The processor may tag groups with attention span style information and associated time information, such as a time stamp or relative time period. The processor may determine attention span style time correlation information based on the tagged data. The attention span style time correlation information may indicate amounts of time and/or specific time periods associated with particular attention span styles of a user. The attention span style time correlation information may be output to be used to better tailor learning materials and scheduling to the user. The method may be implemented, for example, by the computing system 100 of FIG. 1.

Beginning at 200, a processor determines a group of navigation data related to a user's navigation of digital material based on the types of changes in navigation and timing information associated with the navigation such that the group of navigation data is associated with an attention span style.

The digital material may be any suitable digital material,such as learning material. The digital material may be an e-book, lectures, or articles. In one implementation, the digital material an e-book with links or other content types embedded, such as video lectures or links to outside websites. A user may access the digital material in any suitable manner, such as using an e-reader or accessing websites on an electronic device. The learning material may include hybrid digital and print material such that the navigation data is related to user navigation of both digital and print materials and in some cases navigation from a digital learning material to a print learning material. The navigation related to the print material may be determined based on data from an external sensor, such as a camera.

In one implementation, labeling the groups and creating the groups is performed together such that determining whether to add an action to a group is determined based on whether the action fits the attention span classification of the group. The attention span styles may include any suitable attention span styles. In one implementation, the groups are mapped to learning styles related to attention span, such as learning, skimming, and exploring. The groups may be mapped to attention span levels, such where there are ten levels of increasing ability to concentrate. The processor may create the attention span style classifier information based on a comparison of navigation data associated with a set of users to attention span styles associated with that navigation data. For example, a machine learning method may be applied to a group of users navigating through different content, and the classifier may be used to map the attention span group information of future users to attention span styles.

The navigation data may be any suitable data related to how a user navigates the digital material. For example, the user may navigate in a forward manner in an e-book, skip to links to outside material, or skip around the material in the same e-book to different pages. The navigation information may include time stamp information related to the timing of a navigation and/or the time lapse between navigations. The timing information may be used to determine the amount of focus on each selection, such as to determine whether the user is likely reading or skimming,

The session may be any suitable time frame for navigating the digital material. The session may be indicated by the user making an initial selection. In one implementation a processor automatically determines a break between sessions. The processor may delineate sessions in the navigation data, such as based on an amount of inactivity or based on a switch in learning material type. An inactivity threshold may be related to stored information or may be determined based on a machine-leaming method. The inactivity threshold may be associated with an individual user such that it is different for different users. The inactivity threshold may be a time limit between navigation selections. In one implementation, the inactivity threshold is determined based on a histogram of the selections with the threshold automatically selected by a processor based on a degree of change.

In one implementation the classifier is used to identify indications of inactivity. For example, a particular time period without an action may be indicative of inactivity as opposed to focused concentration. The inactivity classifier information may be related to the particular user, such as where one user is a slower reader than another user and a longer time period is used to indicate inactivity. The portions of inactivity may be factored into the clusters and clustered together. The inactivity may be used to divide the interaction into sessions. For example, a shorter period of inactivity may indicate a lower attention span while a longer period of inactivity may indicate the beginning of a new session.

The sessions may be split into smaller segments that are then grouped to allow for multiple types of attention span styles to be identified within a session. In one implementation, the groups are created in an attribute independent manner such that the groups are non-overlapping uniform or non-uniform sized groups to automatically divide up the navigation data, such as based on, amount of time.

In one implementation, the navigation data groups are created based on features associated with the navigation data in the groups such that the groups are created to be homogeneous. The features may include the order in which information is navigated to and the time between navigations. For example, sliding segments of size N may be created over a reading session. The processor may select a set of navigations for a potential group and analyze the potential group to determine if it meets a criteria indicating that the potential group is homogenous. If the group does not satisfy the criteria, such as a threshold, then the processor may increase the size of the potential group, for example, the amount of navigation data or time covered by the potential group, and check again. If a potential group's length exceeds a threshold, then this group may be considered a first group, and the processor may continue the process to identify a second group forward in a timeline of the navigation data.

As an example, a homogeneous group metric may indicate that a group of navigation data is indicative of a same or similar attention span style if adjacent content is accessed in a forward sequential manner and time intervals between changes are similar. In particular, a subsequence {(p1, t1), (p2, t2), (p3, t3), . . . , (pN, tN)} is considered to meet a criteria indicating the subsequence of navigation data is homogenous if Σ|t_{i,i+1}−t̅|/(N−1)<e, where t_{i,i+1}=tᵢ₊₁−tᵢ is the interval between pages pᵢ and pᵢ₊₁ read sequentially and pᵢ being the adjacent data time segment prior to pᵢ₊₁ in the book, t̅ is the average time interval for this sequence, and e is a parameter that controls the reading interval.

As another example, a homogeneous group metric may indicate that a group of navigation is homogenous if adjacent content is accessed in a backward sequential manner and time intervals between changes are similar. In particular, a subsequence {(p1, t1), (p2, t2), (p3, t3), . . . , (pN, tN)} is considered to meet a criteria indicating that the subsequence of navigation data is homogenous if Σ|t_{i,i+1}−t̅|/(N−1)<e, where t_{i,i+1}=tᵢ₊₁−tᵢ is the interval between pages pᵢ and pᵢ₊₁ read sequentially and p being adjacent and after pᵢ₊₁ in the book, t̅ is the average time interval for this sequence, and e is a parameter that controls the interval.

In one implementation, the grouping of the navigation data time segments is based on stored navigation classification data. For example, a particular number of jumps to non-consecutive content in different orders may be a first type, and a quick consecutive change of content may indicate a second type of attention span. The classifier may be used to delineate the different types. For example, some quick consecutive change may still indicate more focus, but there may be a threshold of the amount of data not associated with the same type such that the navigation is still considered to be part of the same group.

A machine-learning method may be performed to determine how to group the navigation data. For example, the navigation data may be clustered based on a clustering method, such as a k-means method or hierarchical method. Features for clustering may include, for example, session time, length of material covered, number of forward moves, number of backward moves, max page distance between navigations, min page distance between navigations and/or session, total page distance, average time per segment/navigation, ratio of forward to backward moves, average page distance for navigation. Groups belonging to the same reading session may be merged. An attention span style classifier may be trained on these groups to recognize whether a new segment belongs to an existing class. The processor may determine whether to classify the segment by adapting classifiers, such as generative classifiers, boundary-based classifiers or distance based classifiers.

Continuing to 201, a processor creates an attention span style time correlation related to the user based on the attention span style information and timing information. In one implementation, a first processor stores the data and creates the attention span groups, and a second processor, such as implementing a second computer program, analyzes the stored data to determine aggregate attention span information. The attention span style time correlation information may be any suitable information related to attention span styles and associated time information. For example, the attention span style time correlation information may indicate an amount of time associated with an attention span style, a comparative amount of time with different attention span styles, and/or relative amount of time spent on an attention span style in order during a session. The processor may determine the time correlation information based on a group of attention span styles and timing associated with the navigation data clustered in the group. The time correlation information may be created by associated multiple groups with the time correlation where each group is representative of an attention span style and associated timing information, such as the earliest and latest time stamp associated with the navigation data in the group. The timing information may be representative as relative timing information based on the time span of the navigation actions, such as ten minutes of high concentration.

The attention span style information may be aggregated across sessions in any suitable manner. For example, the information may be aggregated to determine on average when the attention span of a particular user starts to decline. The processor may group together attention span style time information from user navigation based on factors such as type of media, time of day, or the location of the user. Multiple attention span time correlation information may be created where each is based on a different set of factors.

Continuing to 202, a processor outputs information related to the attention span style time correlation. For example, the processor may transmit, display, or store information related to the determined attention span style time correlation.

In one implementation, the processor classifies the user based on the attention span style information. For example, a machine-learning method may be used to group attention span style time information from multiple users, and the classifier may be used to classify a user based on the attention span style time correlation information, such as where a first group is related to users who sustain a high attention span for a longer period of time and a second group has a high attention span for a brief period before skimming.

In one implementation, the processor automatically groups students for learning purposes based on the learner classification. For example, homogeneous or heterogeneous learning groups may be created where a factor in selecting students in the attention span style time correlation type.

In one implementation, a processor automatically sequences learning material based on the determined attention span style time correlation information. For example, for a user with an initial high attention span and then a shorter attention span, the reading material may be sequenced with in depth reading first and then links to short videos or short articles. The amount of in-depth material may be based on the amount of time that the user is expected to sustain a higher attention span. The processor may select the learning material to be sequenced based on the attention span time correlation information, such as where different users receive different customized text books based on their different attention span time correlation information. The sequenced learning material may be digital, print, or hybrid digital print learning, material.

In one implementation, a processor'creates a learning schedule based on the attention span style information, such as athere a first type of material is for afternoons where the user has shown inc sed attention span and a d eren type cif material for during the day when the user is in a formal school setting.

In one implementation, the processor causes a user interface to be displayed to indicate the attention span style correlation information, such as a time line or other visual indicator that may be displayed to the user or to an educator. For example, an educator may plan a lecture session based on the information displayed.

In one implementation, the processor may cause a notification to be output related to the attention span time correlation information, such as that a user likely skimmed a set of material.

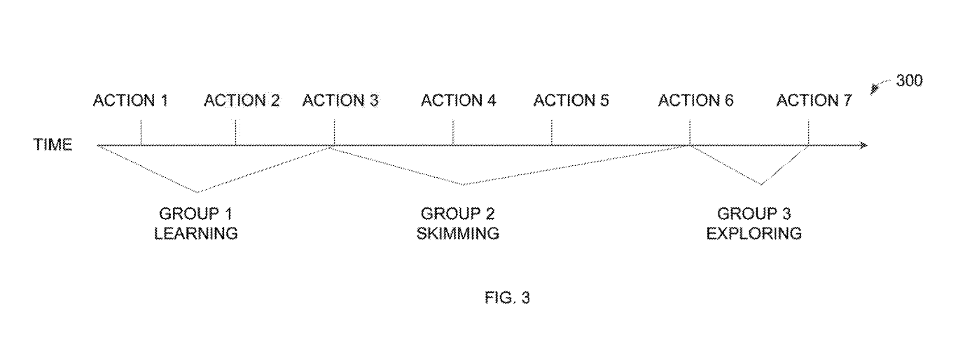

FIG. 3 is a diagram illustrating one example of a timeline 300 indicating attention span style time correlation information. For example, the timeline 300 is marked with a set of seven actions and the time at which the actions occurred. The actions may be a set of navigation selections. The actions may be compared to one another to determine the meaning of an action, such as whether a selection was sequential or out of order. A processor may group the actions into groups. For example, the timeline 300 shows three groups, such as group 1 including actions 1 2, and 3. In one implementation, the processor may disregard some actions in the groups. The processor may then classify each group. For example, group 1 is classified as indicative of learning, group 2 is classified as indicative of skimming, and group 3 is classified as indicative of exploring.

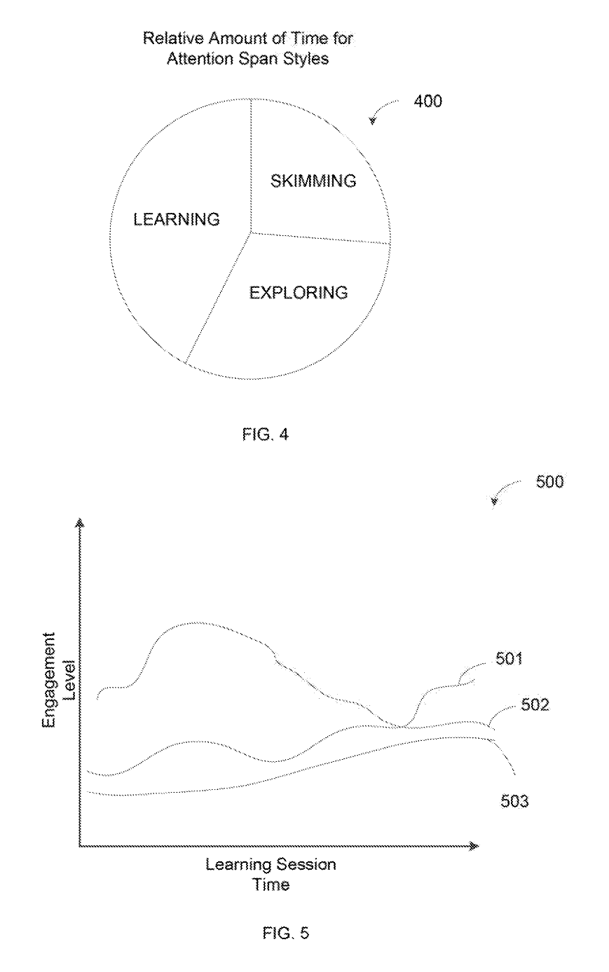

FIG. 4 is a diagram illustrating one example of determining aggregate attention span style type data. In one implementation, the overall session is categorized, such as based on the percentage of different reading styles in the group or the majority attention span group. For example, the pie chart 400, shows that during a defined time period, a user's navigation data indicates more time spent learning than exploring, and more time spent exploring than skimming. In one implementation, a processor causes a user interface to be displayed to show the information about the attention span style types.

FIG. 5 is a diagram illustrating one example of a graph 500 to show a comparison of attention span, style time correlation information related to multiple sers. For example, user 1 is represented by line 501, user 2 is represented by line 502, and user epresented by line 503. The x-axis represents the amount of time, and the y-axis represents the attention span style. For example, the y-axis may indicate specific attention span style types or levels of attention span styles. In one implementation, a processor causes a user interface to be displayed to show a user's attention span change over time, such as to an educator. The graph 500 indicates that the attention span of user 3 steadily increases while the attention span of user 1 increases, peaks, and then decreases.

The attention span style time correlation information may be used to predict how a user would interact with a future learning plan, and learning material and learning scheduling may be performed automatically based on the attention span style time correlation information. For example, articles may be presented to user I in a different order than those presented to user 2 due to the different attention span styles at different times.

1. A computing system, comprising:
a storage to store:
data related to a user's navigation through digital material, wherein the navigation data includes information about changes in content selection and timing information related to the changes in content selection during activity sessions;
attention span style classifier information; and
a processor to:
duster groups of the navigation data based on the types of changes in content selected and the associated timing information,
wherein the groups are associated with attention span styles based on the attention span style classifier information;
determine attention span style time correlation information related to attention span style over time based on the groups; and
output the determined attention span style time correlation information,

2. The computing system of claim 1, wherein the processor is further to:
select attention span style information related to at least one of: a type of media, time of day, or location of a user,
wherein determining attention span style time correlation information comprises determining based on the selected attention span style information.

3. The computing system of claim 1, wherein the processor is further to classify the user based on the attention span style time correlation information.

4. The computing system of claim 1, wherein the processor is further to determine time segments of inactivity and wherein clustering groups takes into account the time segments of inactivity.

5. The computing system of claimwherein the attention span style includes at least one of: learning, skimming, and exploring.

6. A method, comprising:
determining, by a processor, a group of navigation data related to a user's navigation of digital material based on the types of changes in navigation and timing information associated with the navigation,
wherein the group of navigation data is associated with an attention span style based on attention span style classifier information;
create an attention span style time correlation related to the user based on the attention span style information and timing information; and
output information related to the attention span style time correlation.

7. The method of claim 6, wherein the attention span styles comprises at least one of: learning, skimming, and exploring.

8. The method of claim 6, wherein determining a group comprises determining the group based on a comparison of the navigation data compared to stored navigation classification data.

9. The method of claim 6, further comprising creating the attention span style classifier information based on a comparison of navigation data associated with a set of users compared to attention span styles associated with the navigation data.

10. The method of claim 6, wherein creating the attention span style time correlation comprises creating an attention span style time correlation based on information related to a session associated with the attention span style information,

11. A machine-readable non-transitory storage medium comprising instructions executable by a processor to:
determine, based on information related to a users navigation of digital material and stored classifier information, time correlation information related to the user's attention span style; and
output information related to the determination.

12. The machine-readable non-transitory storage medium of claim 11, further comprising instructions to sequence learning material based on the determined information,

13. The machine-readable non-transitory storage medium of claim 11, further comprising instructions to create learning schedule based on the determined information.

14. The machine-readable non-transitory storage medium of claim 11, further comprising instructions to group the user in a learning group based on the determined information.

15. The machine-readable non-transitory storage medium of claim 11, further comprising instructions to cause an attention span style graph be displayed based on the determined information.
